(19) United States
(12) Patent Application Publication
(10) Pub. No.: US 2020/0070379 A1
(43) Pub. Date: Mar. 5, 2020

(54) PANEL CUTTING APPARATUS

(71) Applicant: LITEMAX ELECTRONICS INC., NEW TAIPEI CITY (TW)

(72) Inventor: JUNG-CHI LO, NEW TAIPEI CITY (TW)

(21) Appl. No.: 16/511,074

(22) Filed: Jul. 15, 2019

(30) Foreign Application Priority Data
Aug. 31, 2018 (TW) 107130522

(51) Int. Cl. B26D 5/00; B26D 7/18; B26D 7/27; C03B 33/033; C03B 33/027; C03B 33/037

(52) U.S. Cl. CPC B26D 5/007; B26D 7/1845; C03B 33/037; C03B 33/033; C03B 33/027; B26D 7/27

(57) ABSTRACT

A panel cutting apparatus includes a master cutting apparatus. The master cutting apparatus includes a casing, wheels, a first servo motor, a second servo motor, a processing unit, an image sensing unit and an integrated jig unit. The wheels are disposed on the bottom surface of the casing, and its rotation is controlled by the second servo motor. The image sensing unit is electrically connected to the processing unit and disposed at the front end of the lateral surface of the casing to sense images in front of the panel cutting apparatus. The processing unit controls the second servo motor according to the sensed images. The integrated jig unit is disposed on the top surface of the casing and includes jigs and a jig changing unit. The jig changing unit switches between the jigs and selects one of them. The selected jig is controlled by the first servo motor.

### CROSS-REFERENCE TO RELATED APPLICATION

This non-provisional application claims priority under 35 U.S.C. § 119(a) on Patent Application No(s). 107130522 filed in Taiwan, R.O.C. on Aug. 31, 2018, the entire contents of which are hereby incorporated by reference.

### BACKGROUND OF THE INVENTION

### 1. Field of the Invention

The present disclosure relates to panel cutting apparatuses, and in particular to a panel cutting apparatus not subject to limitation of panel size.

### 2. Description of the Related Art

In general, to cut cost, panel suppliers manufacture large-sized panels, then cut the large-sized panels into small-sized panels, and finally provide the small-sized panels to clients. To cut the large-sized panels, conventional panel cutting apparatuses are mostly large-sized cutting machines. Hence, the conventional panel cutting apparatuses are bulky and expensive. Furthermore, since the conventional panel cutting apparatuses are bulky, the conventional panel cutting apparatuses are mostly mounted in place at factories and thus are not portable.

In some circumstances, product design entails cutting panels on the spot or cutting panels very often. However, in the eyes of product designers, bulky conventional panel cutting apparatuses are neither cost-efficient nor compact enough to be placed in a factory or a practical space. Hence, it is necessary to provide a panel cutting apparatus which is compact and portable.

### BRIEF SUMMARY OF THE INVENTION

An objective of the present disclosure is to provide a panel cutting apparatus which is compact and portable. Furthermore, an embodiment of the present disclosure provides a panel cutting apparatus which incurs low cost and thus are affordable by product designer and shallow-pocketed dealers.

To achieve at least the above objective, the present disclosure provides a panel cutting apparatus which comprises a master (master) cutting apparatus. The master cutting apparatus comprises a first casing, a plurality of wheels, an image sensing unit and a first integrated jig unit. The first casing has therein a first servo motor, second servo motor and first processing unit, wherein the first processing unit is electrically connected to the first servo motor and second servo motor to control the first servo motor and second servo motor. The plurality of wheels is disposed on the bottom surface of the first casing, with its rotation being controlled by the second servo motor. The image sensing unit is electrically connected to the first processing unit and disposed at the front end of the lateral surface of the first casing to sense images in front of the panel cutting apparatus. The first processing unit controls the second servo motor according to images sensed by the sensing unit. The first integrated jig unit is disposed on the top surface of the first casing and comprises a plurality of first jigs and a first jig changing unit. The first jig changing unit is electrically connected to the first processing unit and controlled by the first processing unit to switch between the plurality of first jigs and select one of them. The selected first jig is connected to the first servo motor and controlled by the first servo motor.

Optionally, in an embodiment of the present disclosure, the master cutting apparatus further comprises a first suction unit and a first communication unit. The first suction unit is electrically connected to the first processing unit and adhered to a slave cutting apparatus for expansion. The first communication unit is electrically connected to the first processing unit to communicate with the slave cutting apparatus.

Optionally, in an embodiment of the present disclosure, the panel cutting apparatus further comprises a slave cutting apparatus. The slave cutting apparatus comprises a second casing, second integrated jig unit, second suction unit and second communication unit. The second casing has therein a third servo motor and second processing unit, wherein the second processing unit is electrically connected to the third servo motor to control the third servo motor. The second integrated jig unit is disposed on the top surface of the second casing and comprises a plurality of second jigs and a second jig changing unit. The second jig changing unit is electrically connected to the second processing unit and controlled by the second processing unit to switch between the plurality of second jigs and select one of them, wherein the selected second jig is connected to the third servo motor and controlled by the second servo motor. The second suction unit is electrically connected to the second processing unit to adhere to the master cutting apparatus. The second communication unit is electrically connected to the second processing unit to communicate with the master cutting apparatus.

Optionally, in an embodiment of the present disclosure, the panel cutting apparatus further comprises a slave cutting apparatus. The slave cutting apparatus comprises a second casing, second integrated jig unit and second communication unit. The second casing has therein a third servo motor and second processing unit, wherein the second processing unit is electrically connected to the third servo motor to control the third servo motor. The second integrated jig unit is disposed on the top surface of the second casing and comprises a plurality of second jigs and a second jig changing unit. The second jig changing unit is electrically connected to the second processing unit and controlled by the second processing unit to switch between the plurality of second jigs and select one of them, wherein the selected second jig is connected to the third servo motor and controlled by the second servo motor. The second communication unit is electrically connected to the second processing unit to communicate with the master cutting apparatus. The two ends of the connection arm are connected to the two ends of the two lateral surfaces of the two casings of the master cutting apparatus and the slave cutting apparatus.

Optionally, in an embodiment of the present disclosure, the two ends of the two lateral surfaces of the two casings connected to the connection arm are on the left of the image sensing unit.

Optionally, in an embodiment of the present disclosure, the distance between the two ends of the connection arm is adjustable.

Optionally, in an embodiment of the present disclosure, a plurality of first jigs each comprise a glass cutter, a polarizer cutter, a scrap remover and a glue dispenser.

Optionally, in an embodiment of the present disclosure, the first processing unit determines the cutting speed of the selected first jig according to the thickness of the panel to cut and the cutter wheel pressure of the selected first jig.

Optionally, in an embodiment of the present disclosure, the first and second suction units are two electromagnetic units.

Optionally, in an embodiment of the present disclosure, the master cutting apparatus further comprises a vacuum unit. The vacuum unit sucks air such that almost no air exists at the point of contact between the panel to cut and the master cutting apparatus.

In short, the panel cutting apparatus provided by embodiments of the present disclosure is advantageously compact, portable and cheap.

### BRIEF DESCRIPTION OF THE DRAWINGS

FIG. 1A is a schematic view of a panel cutting apparatus according to an embodiment of the present disclosure.

FIG. 1B is a schematic view of the panel cutting apparatus according to another embodiment of the present disclosure.

FIG. 1C is a schematic view of the panel cutting apparatus according to yet another embodiment of the present disclosure.

FIG. 2 is a block diagram of a master cutting apparatus according to an embodiment of the present disclosure.

FIG. 3A is a lateral view of the panel cutting apparatus for cutting a panel according to an embodiment of the present disclosure.

FIG. 3B is a top view of the panel cutting apparatus for cutting a panel according to an embodiment of the present disclosure.

FIG. 4 is a lateral view of the panel cutting apparatus for cutting a panel according to another embodiment of the present disclosure.

FIG. 5A is a lateral view of the panel cutting apparatus for cutting a panel according to another embodiment of the present disclosure.

FIG. 5B is a top view of the panel cutting apparatus for cutting a panel according to another embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

An embodiment of the present disclosure provides a compact panel cutting apparatus for cutting a panel of whatever size. The panel cutting apparatus comprises a master cutting apparatus. A plurality of wheels is disposed on the bottom surface of the casing of the master cutting apparatus such that the master cutting apparatus moves because of the rotation of the wheels. An image sensing unit is disposed at the front end of the lateral surface of the casing of the master cutting apparatus to sense images in front of the panel cutting apparatus, allowing a processing unit of the master cutting apparatus to control the rotation of the wheels according to the sensed images. An integrated jig unit is disposed on the top surface of the casing of the master cutting apparatus and has jigs. The processing unit controls the integrated jig unit to select one of the jigs to perform one of a cutting process, a glue dispensing process and a cleaning process.

Optionally, the panel cutting apparatus further comprises a slave cutting apparatus. Suction units corresponding in position to each other are disposed on the top surface of the casing of the master cutting apparatus and the bottom surface of the casing of the slave cutting apparatus such that the master cutting apparatus and the slave cutting apparatus adhere to each other and thereby move synchronously in order to cut a panel located between the master cutting apparatus and the slave cutting apparatus. An integrated jig unit is disposed on the bottom surface of the casing of the slave cutting apparatus and has a plurality of jigs. The processing unit controls the integrated jig unit to select one of a plurality of jigs to perform one of a cutting process, a glue dispensing process and a cleaning process. Hence, the panel cutting apparatus can cut two panels simultaneously or perform different processes on the same panel simultaneously, for example, cutting and dispensing glue simultaneously, cutting and cleaning simultaneously, or cutting glass and polarizer simultaneously.

Optionally, the master cutting apparatus and the slave cutting apparatus lack any suction unit but are connected by an adjustable connection arm. The linear distance between the two ends of the adjustable connection arm (i.e., the distance between the master cutting apparatus and the slave cutting apparatus) can be adjusted by adjusting its curvature. The two ends of the adjustable connection arm are connected to the two ends of the two lateral surfaces of the two casings of the master cutting apparatus and the slave cutting apparatus. The adjustable connection arm must not come into contact with the panel to cut but must enable the image sensing unit to sense images in front of the master and slave cutting apparatuses (for example, the two ends are on the left of the image sensing unit).

Both the master cutting apparatus and the slave cutting apparatus have a servo motor for controlling the cutting speed of the jigs (such as glass cutters or polarizer cutters). The processing unit controls the servo motor according to the thickness of the panel to cut and the cutter wheel pressure of the jigs, so as for the servo motor to further control the cutting speed of the jigs. The master cutting apparatus further has a servo motor for controlling the rotation speed of the wheels (i.e., the master cutting apparatus has two servo motors for controlling the rotation speed of the wheels and the cutting speed of the jigs.)

The general operating principles about the panel cutting apparatus of the embodiments of the present disclosure are described above. Details and operation of the panel cutting apparatus of the embodiments of the present disclosure are depicted by the accompanying drawings and described below.

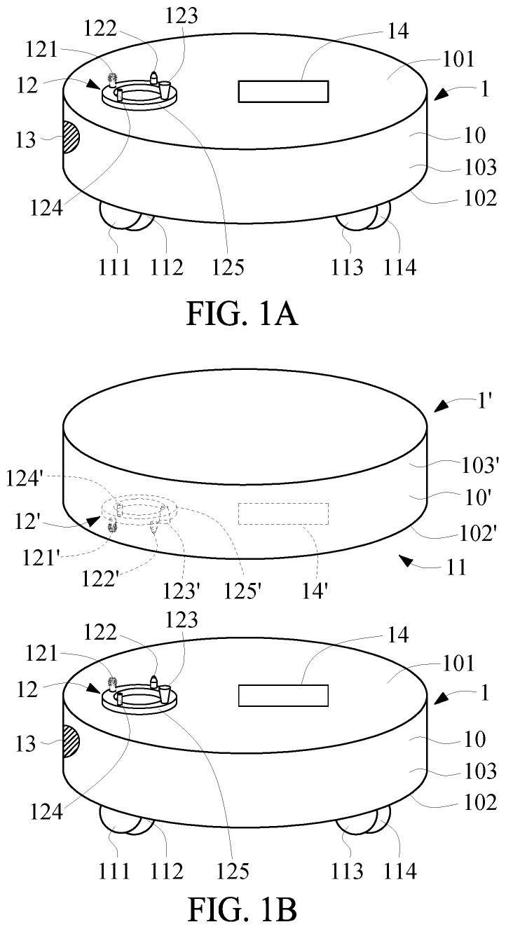

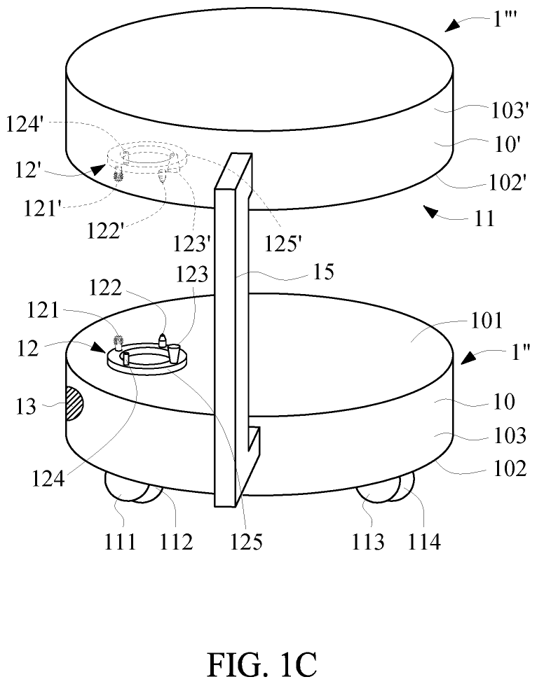

Referring to FIG. 1A, FIG. 1A is a schematic view of a panel cutting apparatus according to an embodiment of the present disclosure. In this embodiment, the panel cutting apparatus comprises a master cutting apparatus 1. The master cutting apparatus 1 comprises a casing 10, a plurality of wheels 111˜114, an integrated jig unit 12, an image sensing unit 13, a processing unit (not shown in FIG. 1), a first servo motor (not shown in FIG. 1) and a second servo motor (not shown in FIG. 1), wherein the processing unit, first servo motor and second servo motor are disposed inside the casing 10.

The plurality of wheels 111˜114 are disposed on the bottom surface 102 of the casing 10, connected to the second servo motor, and thereby controlled by the second servo motor. Owing to the rotation of the plurality of wheels 111˜114, the master cutting apparatus 1 can move. The image sensing unit 13 is disposed at the front end of the lateral surface 103 of the casing 10 to sense images in front of the master cutting apparatus 1. The processing unit controls the second servo motor according to the sensed images and thereby controls the rotation of the wheels. Hence, the processing unit performs computation on the sensed images, allowing the panel cutting apparatus to effect positioning and smart vision. The image sensing unit 13 is in the number of one or more and can be located at any point other than the front end of the lateral surface 103, so as to augment smart vision.

The integrated jig unit 12 is disposed on the top surface 101 of the casing 10 and comprises a plurality of jigs, such as a glass cutter 121, a polarizer cutter 122, a scrap collector 123, a glue dispenser 124 and a jig changing unit 125. The jig changing unit 125 is controlled by the processing unit and adapted to switch between a plurality of jigs and select one of them. The first servo motor is controlled by the processing unit. The first servo motor is connected to the integrated jig unit 12 to control the selected jig. For instance, if the selected jig is the glass cutter 121 or polarizer cutter 122, the processing unit will instruct the first servo motor to control the cutting speed of the glass cutter 121 or polarizer cutter 122 according to the cutter wheel pressure of the glass cutter 121 or polarizer cutter 122 and the thickness of the panel to cut. If the selected jig is the scrap collector 123 or glue dispenser 124, the processing unit will instruct the first servo motor to control the scrap collection wind speed of the scrap collector 123 or the amount of glue dispensed with the glue dispenser 124 according to the actual situation or user's configurations. The aforesaid types and numbers of the jigs only serve exemplary purposes, and the present disclosure is not restrictive of the types and numbers of the jigs of the integrated jig unit 12.

Preferably, to expand the panel cutting apparatus and thereby contain the slave cutting apparatus, the master cutting apparatus 1 further comprises a suction unit 14 for adhering to the slave cutting apparatus located at the other end of the panel to cut. For instance, the suction unit 14 is an electromagnetic unit, whereas the suction unit of the slave cutting apparatus is also an electromagnetic unit; hence, the master cutting apparatus 1 and the slave cutting apparatus adhere to each other under a force at a distance, allowing the slave cutting apparatus and the master cutting apparatus 1 to move synchronously. The master cutting apparatus 1 further comprises a vacuum unit (not shown in FIG. 1) for sucking air such that almost no air exists at the point of contact between the panel and the master cutting apparatus to ensure that during the cutting process no trace of air can enter the lateral edge of the cut panel to otherwise cause defects of the panel. Preferably, the master cutting apparatus 1 further comprises a communication unit which communicates with the communication unit of the slave cutting apparatus to enable communication between the master cutting apparatus 1 and the slave cutting apparatus for jointly performing the cutting process planned by the user.

Referring to FIG. 1B, FIG. 1B is a schematic view of the panel cutting apparatus according to another embodiment of the present disclosure. In this embodiment, the panel cutting apparatus comprises the master cutting apparatus 1 and the slave cutting apparatus 1′. The master cutting apparatus 1 in FIG. 1B is identical to the master cutting apparatus 1 in FIG. 1A and thus, for the sake of brevity, is not described hereunder. The slave cutting apparatus 1′ comprises the casing 10′, the integrated jig unit 12′, the suction unit 14′, the first servo motor, the processing unit and the communication unit. The suction units 14, 14′ enable the slave cutting apparatus 1′ and the master cutting apparatus 1 to adhere to each other even though they are separated by the panel to cut and enable the slave cutting apparatus 1′ and the master cutting apparatus 1 to move synchronously. The slave cutting apparatus 1′ and the master cutting apparatus 1 correspond in position to the suction unit 14. The suction unit 14′ is disposed on the bottom surface 102′ of the casing 10′. The slave cutting apparatus 1′ and the master cutting apparatus 1 communicate with each other through the communication unit.

Like the master cutting apparatus 1, the integrated jig unit 12′ and the jig changing unit 125′ of the slave cutting apparatus 1′ are controlled by the processing unit to switch between a plurality of jigs and select one of them. The jigs each comprise a glass cutter 121′, a polarizer cutter 122′, a scrap collector 123′ and a glue dispenser 124′, but the present invention is not limited thereto. The first servo motor of the slave cutting apparatus 1′ is controlled by the processing unit of the slave cutting apparatus 1′, and the first servo motor controls the cutting speed of the glass cutter 121′ and polarizer cutter 122′, the scrap collection wind speed of the scrap collector 123′, and the amount of glue dispensed with the glue dispenser 124′.

Referring to FIG. 1C, FIG. 1C is a schematic view of the panel cutting apparatus according to yet another embodiment of the present disclosure. The panel cutting apparatus comprises the master cutting apparatus 1″ and the slave cutting apparatus 1″′. Unlike the master cutting apparatus 1 and the slave cutting apparatus 1′ in FIG. 1B, the master cutting apparatus 1″ and the slave cutting apparatus 1′″ lack a suction unit. Referring to FIG. 1C, the panel cutting apparatus further comprises an adjustable connection arm 15. The two ends of the adjustable connection arm 15 are connected to the two ends of two lateral surface 103, 103′ of the two casings 10, 10′ of the master cutting apparatus 1″ and the slave cutting apparatus 1″′. The adjustable connection arm 15 must not come into contact with the panel to cut but must enable the image sensing unit 13 to sense images in front of the master and slave cutting apparatuses 1″, 1″′ (for example, the two ends are on the left of the image sensing unit 13).

Although the master cutting apparatus 1, 1″ and the slave cutting apparatus 1′, 1′″ in the above embodiments are cylindrical for exemplary purposes, the present disclosure is not restrictive of the master cutting apparatus 1, 1″ and the slave cutting apparatus 1′, 1′″. For instance, the master cutting apparatus 1, 1″ and the slave cutting apparatus 1′, 1′″ can be columnar with a polygonal cross section.

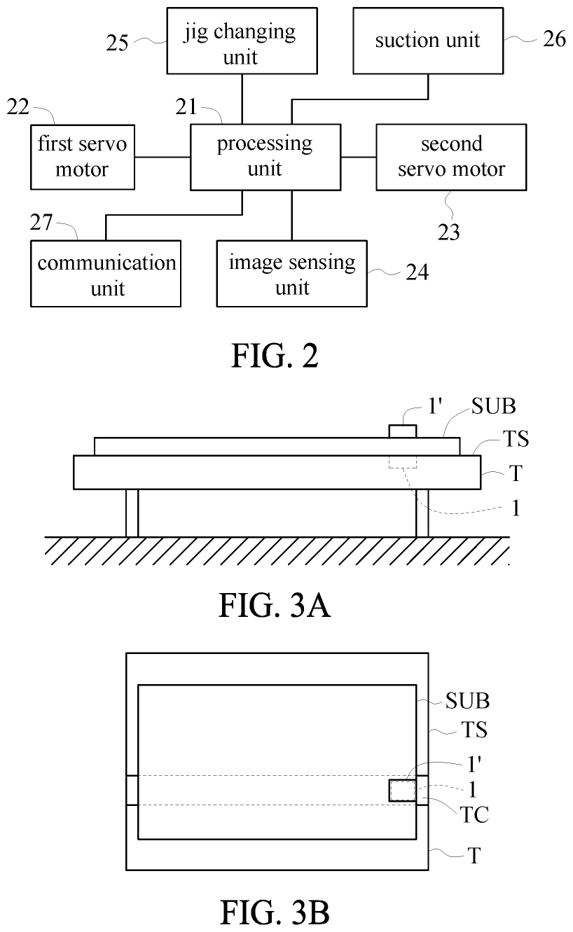

Referring to FIG. 2, FIG. 2 is a block diagram of a master cutting apparatus according to an embodiment of the present disclosure. The master cutting apparatus comprises a processing unit 21, first servo motor 22, second servo motor 23, image sensing unit 24, jig changing unit 25, suction unit 26 and communication unit 27. The processing unit 21 is electrically connected to the first servo motor 22, second servo motor 23, image sensing unit 24, jig changing unit 25, suction unit 26 and communication unit 27.

The processing unit 21 controls the first servo motor 22, second servo motor 23, image sensing unit 24, jig changing unit 25, suction unit 26 and communication unit 27. The image sensing unit 24 senses images in front of the master cutting apparatus and sends the sensed images to the processing unit 21; hence, the processing unit 21 controls the second servo motor 23 to control the rotation speed of the wheels according to the sensed images. Therefore, by sensing images, it is feasible to control the motion of the master cutting apparatus. The processing unit 21 controls the first servo motor 21 according to the thickness of the panel to cut and the cutter wheel pressure of the jigs, so as to control the speed of the jigs with the first servo motor 21 or control the scrap collection wind speed of the jigs and the amount of glue dispensed according to the other factors. The jig changing unit 25 is controlled by the processing unit 21 so as to switch between a plurality of jigs of the integrated jig unit and select one of them. The suction unit 26 is controlled by the processing unit 21 and adapted to adhere to the slave cutting apparatus. The communication unit 27 communicates with the communication unit of the slave cutting apparatus such that the master cutting apparatus and the slave cutting apparatus can operate in conjunction with each other. The circuit of the slave cutting apparatus is similar to the circuit of the master cutting apparatus but lacks the second servo motor 23 and the image sensing unit 24.

Referring to FIG. 3A and FIG. 3B, FIG. 3A is a lateral view of the panel cutting apparatus for cutting a panel according to an embodiment of the present disclosure, whereas FIG. 3B is a top view of the panel cutting apparatus for cutting a panel according to an embodiment of the present disclosure. Operation of the panel cutting apparatus is described below. First, the master cutting apparatus 1 is placed in a cutting channel TC in an operating surface TS of a workbench. Next, panel SUB is placed on the operating surface TS. The operating surface TS has a plurality of positioning points or positioning elements (not shown in FIG. 3A and FIG. 3B). Then, the slave cutting apparatus 1′ is placed on panel SUB, allowing the master cutting apparatus 1 and slave cutting apparatus 1′ to adhere to each other with the suction unit. Then, the master cutting apparatus 1 and slave cutting apparatus 1′ move synchronously along cutting channel TC to perform a cutting process on panel SUB, for example, cutting the glass and the polarizer of panel SUB simultaneously or cutting and dispensing glue to the panel simultaneously.

Although this embodiment is exemplified by cutting panel SUB with the master cutting apparatus 1 and slave cutting apparatus 1′, it is feasible to cut panel SUB with only one said master cutting apparatus 1. Furthermore, as illustrated with the embodiment below, the panel to cut is in the number of two.

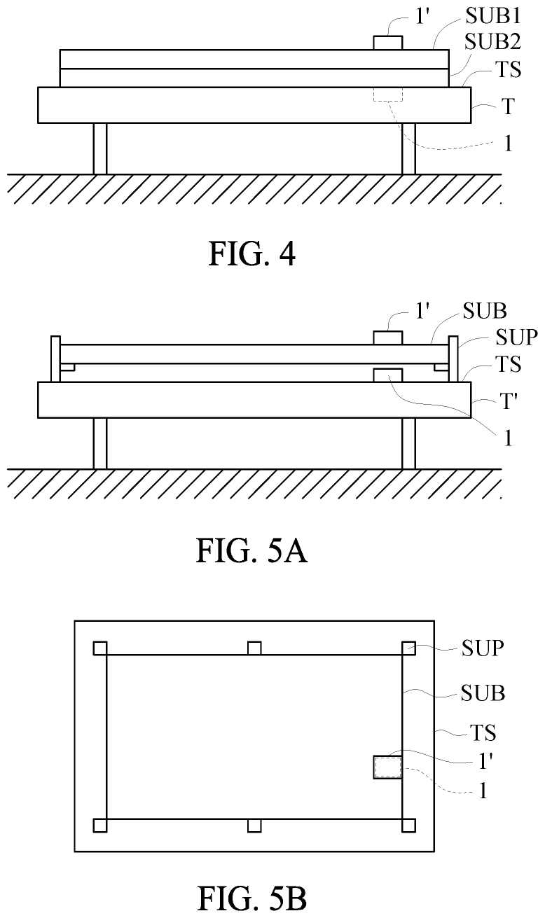

Referring to FIG. 4, FIG. 4 is a lateral view of the panel cutting apparatus for cutting a panel according to another embodiment of the present disclosure. Operation of the panel cutting apparatus is described below. First, the master cutting apparatus 1 is placed in a cutting channel TC in an operating surface TS of a workbench. Next, panel SUB1 and SUB2 are placed on the operating surface TS. Then, the slave cutting apparatus 1′ is placed on panel SUB2, allowing the master cutting apparatus 1 and slave cutting apparatus 1′ to adhere to each other with the suction unit. After that, the master cutting apparatus 1 and slave cutting apparatus 1′ move synchronously along the cutting channel TC, so as to perform a cutting process on panel SUB1 and SUB2. In this embodiment, panel SUB1 and panel SUB2 are cut with the master cutting apparatus 1 and slave cutting apparatus 1′, respectively.

The above embodiments are exemplified by a workbench T with a cutting channel TC, but the panel cutting apparatus of the present disclosure is not limited thereto. Referring to FIG. 5A and FIG. 5B, FIG. 5A is a lateral view of the panel cutting apparatus for cutting a panel according to another embodiment of the present disclosure, whereas FIG. 5B is a top view of the panel cutting apparatus for cutting a panel according to another embodiment of the present disclosure. Operation of the panel cutting apparatus is described below. First, the master cutting apparatus 1 is placed on the operating surface TS of the workbench T′. Next, panel SUB is placed on a carrying structure SUP of the workbench T′, and there is a height between the carrying structure SUP and the operating surface TS. Then, the slave cutting apparatus 1′ is placed on panel SUB, allowing the master cutting apparatus 1 and slave cutting apparatus 1′ to adhere to each other with the suction unit. After that, the master cutting apparatus 1 and slave cutting apparatus 1′ move synchronously, so as to perform a cutting process on panel SUB, for example, cutting the glass and the polarizer of panel SUB simultaneously or cutting and dispensing glue to the panel simultaneously.

Therefore, embodiments of the present disclosure provide a panel cutting apparatus for cutting a panel of whatever size so as to obtain a panel of desirable size. Unlike a bulky conventional panel cutting apparatus, the panel cutting apparatus of the embodiments of the present disclosure is almost of the same size as commercially-available robotic vacuum cleaners and thus is for use on a workbench with or without a cutting channel to cut a panel. Hence, the panel cutting apparatus of the embodiments of the present disclosure is compact, portable and cheap. Thanks to the integrated jig unit, the panel cutting apparatus not only cuts glass but also cuts a polarizer, dispenses glue, and removes scraps. The panel cutting apparatus not only includes the master cutting apparatus but also includes a slave cutting apparatus which moves synchronously with the master cutting apparatus, so as to cut two panels simultaneously, cut and dispense glue to a panel simultaneously, or cut and remove scraps from a panel simultaneously.

While the present disclosure has been described by means of specific embodiments, numerous modifications and variations could be made thereto by those skilled in the art without departing from the scope and spirit of the present disclosure set forth in the claims.

What is claimed is:

1. A panel cutting apparatus, comprising:
a master cutting apparatus, comprising:
a first casing having therein a first servo motor, a second servo motor and a first processing unit, wherein the first processing unit is electrically connected to the first servo motor and the second servo motor to control the first servo motor and the second servo motor;
a plurality of wheels disposed on a bottom surface of the first casing, with its rotation being controlled by the second servo motor;
an image sensing unit electrically connected to the first processing unit and disposed at a front end of a lateral surface of the first casing to sense images in front of the panel cutting apparatus, wherein the first processing unit controls the second servo motor according to the images sensed by the image sensing unit; and
a first integrated jig unit disposed on a top surface of the first casing and comprising a plurality of first jigs and a first jig changing unit, with the first jig changing unit electrically connected to the first processing unit and controlled by the first processing unit to switch between the plurality of first jigs and select one of them, wherein the selected first jig is connected to the first servo motor and controlled by the first servo motor.

2. The panel cutting apparatus of claim 1, wherein the master cutting apparatus further comprises:
a first suction unit electrically connected to the first processing unit and adhered to a slave cutting apparatus for expansion; and
a first communication unit electrically connected to the first processing unit to communicate with the slave cutting apparatus.

3. The panel cutting apparatus of claim 2, further comprising the slave cutting apparatus, the slave cutting apparatus comprising:
a second casing having therein a third servo motor and a second processing unit, wherein the second processing unit is electrically connected to the third servo motor to control the third servo motor;
a second integrated jig unit disposed on a top surface of the second casing and comprising a plurality of second jigs and a second jig changing unit, wherein the second jig changing unit is electrically connected to the second processing unit and controlled by the second processing unit to switch between the plurality of second jigs and select one of them, wherein the selected second jig is connected to the third servo motor and controlled by the second servo motor;
a second suction unit electrically connected to the second processing unit to adhere to the master cutting apparatus; and
a second communication unit electrically connected to the second processing unit to communicate with the master cutting apparatus.

4. The panel cutting apparatus of claim 1, further comprising:
a slave cutting apparatus, comprising:
a second casing having therein a third servo motor and a second processing unit, wherein the second processing unit is electrically connected to the third servo motor to control the third servo motor;
a second integrated jig unit disposed on a top surface of the second casing and comprising a plurality of second jigs and a second jig changing unit, wherein the second jig changing unit is electrically connected to the second processing unit and controlled by the second processing unit to switch between the plurality of second jigs and select one of them, wherein the selected second jig is connected to the third servo motor and controlled by the second servo motor; and
a second communication unit electrically connected to the second processing unit to communicate with the master cutting apparatus; and
a connection arm with two ends connected to two ends of two lateral surfaces of the two casings of the master cutting apparatus and the slave cutting apparatus.

5. The panel cutting apparatus of claim 4, wherein two ends of two lateral surfaces of the two casings connected to the connection arm are on the left of the image sensing unit.

6. The panel cutting apparatus of claim 4, wherein a distance between two ends of the connection arm is adjustable.

7. The panel cutting apparatus of claim 1, wherein the first jigs each comprise a glass cutter, a polarizer cutter, a scrap remover and a glue dispenser.

8. The panel cutting apparatus of claim 1, wherein the first processing unit determines a cutting speed of the selected first jig according to thickness of a panel to cut and cutter wheel pressure of the selected first jig.

9. The panel cutting apparatus of claim 3, wherein the first and second suction units are two electromagnetic units.

10. The panel cutting apparatus of claim 1, wherein the master cutting apparatus further comprises a vacuum unit for sucking air such that almost no air exists at a point of contact between a panel to cut and the master cutting apparatus.
